(19) United States
(12) Patent Application Publication
(10) Pub. No.: US 2005/0056170 A1
(43) Pub. Date: Mar. 17, 2005

(54) Method and apparatus for emulsification

(75) Inventors: Makoto Koike, Fujinomiya-shi (JP); Shotaro Ogawa, Fujinomiya-shi (JP); Hideo Nagano, Fujinomiya-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/926,046

(22) Filed: Aug. 26, 2004

(30) Foreign Application Priority Data
Aug. 27, 2003 (JP) 2003-208967

(51) Int. Cl. G03G 5/00

(52) U.S. Cl. 101/146

(57) ABSTRACT

An emulsification apparatus is used in a production apparatus of microcapsules. The emulsification apparatus is constituted with an outer cylinder and an inner cylinder coaxially arranged in a superposed manner, the outer cylinder is fixed, and the inner cylinder is rotated at a circumferential speed ω. A liquid being processed is fed into the gap between the outer cylinder and the inner cylinder, thus a shear force is exerted to the liquid being processed, and the liquid being processed is thereby emulsified. The relation between the magnitude d (mm) of the gap, the viscosity η (mPa·sec) of the liquid being processed and the circumferential speed ω (m/sec) of the inner cylinder is such that the circumferential speed co is controlled so that any one of the following relations may be satisfied: (1) When η≦20, d≦5/ω; (2) When 20<η≦50, d≦10/ω; (3) When 50<η≦100, d≦20/ω; (4) When 100<η.

### BACKGROUND OF THE INVENTION

1. Field of the Invention

The present invention is involved in a method and an apparatus for emulsification, and particularly, relates to a method and an apparatus for emulsification to be used for a step in production of microcapsules.

2. Description of the Related Art

Microcapsules are used in a wide range of fields involving recording materials, agricultural chemicals, electronic paper, drug delivery systems and the like.

In the production of a microcapsule, there are demanded a technique attaining the average particle size in conformity with product performances, and furthermore, even a technique for uniformizing the sizes of the individual particles, namely, a technique for sharpening the particle diameter distribution. For example, when a microcapsule is applied to pressure sensitive paper, there is a problem in that fine particles each alone do not contribute to coloration, whereas on the contrary, coarse particles tend to develop colors in response to a faint contact. Therefore, it is important to uniformize the sizes of the individual particles to an appropriate magnitude at the time of producing the microcapsule.

As a method for producing a microcapsule, a method is known in which an aqueous phase and an oil phase, mutually insoluble, are mixed together and emulsified, and a wall film is formed around each of the produced liquid droplets. In this method, the average particle diameter and the particle diameter distribution are determined in the step of emulsification. As the apparatus used in the step of emulsification, there have hitherto been known a high speed stirrer (dissolver), a high pressure homogenizer, a supersonic emulsification apparatus and the like.

However, in any of the apparatuses, as the force contributing to emulsification, shear force, collisional force, cavitation and the like are involved in a complicated manner, so that microscopically the force distribution in a liquid being processed becomes nonuniform. Accordingly, by use of these apparatuses, no microcapsule having a desired average particle diameter and a sharp particle diameter distribution has hitherto been able to be produced.

Japanese Patent No. 2630501 describes a method for emulsification in which a so-called cylindrical mill is used. This method for emulsification is a method for emulsification in which an inner cylinder is rotated in a fixed outer cylinder, a mixed liquid of a dispersion medium and a dispersion liquid is made to pass through the gap between the inner cylinder and the outer cylinder and thus an emulsified liquid is obtained. The particle diameter of the liquid droplets obtained by this method for emulsification depends on the rotation number of the inner cylinder and the magnitude of the gap between the inner cylinder and the outer cylinder; and for the average particle diameter of 5 mm or larger, a sharp particle diameter distribution is obtained.

### SUMMARY OF THE INVENTION

However, in these years, microcapsules each having a sharper particle diameter distribution than the particle diameter distribution obtained in Japanese Patent No. 2630501 are demanded, and particularly, microcapsules each having a sharp particle diameter distribution for the average particle diameter of the order of 1 μm or less are demanded.

The present invention has been achieved in view of these circumstances, and takes as an object thereof the provision of a method and an apparatus for emulsification which can easily control the average particle diameter and can produce emulsified liquids each having a sharp particle diameter distribution. Additionally, the present invention takes as another object thereof the provision of emulsified liquids produced by the method and apparatus for emulsification, and microcapsules produced by use of the emulsified liquids.

A first aspect of the present invention is a method for emulsification in which for the purpose of achieving the above described objects, a liquid being processed comprising an aqueous phase and an oil phase is made to pass through a gap between an outer cylinder and an inner cylinder arranged coaxially in the outer cylinder, and said liquid being emulsified by rotating at least one of the outer cylinder and the inner cylinder, comprising: forming a laminar flow state without any vortex flow in the liquid being processed which is flowing in the gap.

The inventors of the present invention analyzed the flow of the liquid being processed in the gap between the outer cylinder and the inner cylinder, and investigated the causal relation between the analyzed flow and the particle diameter distribution of the produced microcapsule, and thus obtained a finding that when vortex flow and turbulent flow are generated in the liquid being processed flowing in the gap, the particle diameter distribution of the microcapsule becomes broad. On the contrary, there was obtained a finding that when a laminar flow state without any vortex flow is formed in the liquid being processed in the gap, the particle diameter distribution of the microcapsule becomes sharp. Furthermore, there was obtained a fining that the flow of the liquid being processed in the gap is varied depending on the relation between the viscosity η of the liquid being processed, the magnitude d of the gap, and the circumferential speed ω of the inner cylinder (rotational speed of the inner cylinder at outer wall surface); and when the relation satisfies any one of the relations (1) to (4) described in the second or fifth aspect, a laminar flow state without any vortex flow is formed.

The present invention was achieved on the basis of these findings, and according to the first aspect of the present invention, in the liquid being processed flowing in the gap between the inner cylinder and the outer cylinder, a laminar flow state without any vortex flow is formed, so that a uniform shear force is exerted to the liquid being processed. Accordingly, there can be produced an emulsified liquid in which liquid droplets are dispersed in a uniform size, and by use of the emulsified liquid, there can be produced a microcapsule having a sharp particle diameter distribution.

A second aspect of the present invention is characterized in that in the first aspect of the present invention, the magnitude d (mm) of the gap falls within the range of 0.01 to 2 mm and is constant; the axial direction length of the inner cylinder is two or more times the magnitude d of the gap; and when the outer cylinder is fixed and the inner cylinder is rotated at a circumferential speed ω (m/sec), the relation between the viscosity η (mPa·sec) of the liquid being processed, the circumferential speed ω, and the magnitude d of the gap satisfies any one of the following relations: (1) when η≦20, d<5/ω); (2) when 20<η≦50, d≦10/ω); (3) when 50<η≦100, d≦20/ω; and (4) 100<η.

According to the second aspect, when the relation between the viscosity η, the circumferential speed ω, and the magnitude d of the gap is such that the relation satisfies any one of the above described relations (1) to (4), a laminar flow state without any vortex flow is formed in the liquid being processed flowing in the gap.

A third aspect of the present invention is characterized in that an emulsified liquid is obtained by use of the method for emulsification of the first aspect or the second aspect.

A fourth aspect of the present invention is characterized in that a microcapsule is produced by use of the emulsified liquid of the third aspect.

A fifth aspect of the present invention is an apparatus for emulsification including, for the purpose of achieving the above described objects, an outer cylinder, an inner cylinder arranged coaxially in the outer cylinder, a rotation driving device for rotating the inner cylinder, a feeding device for feeding a liquid being processed, comprising an aqueous phase and an oil phase, into a gap between the inner cylinder and the outer cylinder, wherein when the magnitude d (mm) of the gap falls within the range of 0.01 to 2 mm and is constant, and the axial direction length of the inner cylinder is two or more times the magnitude d of the gap, the apparatus for emulsification includes a controller for controlling the circumferential speed ω of the inner cylinder in such a way that the relation between the viscosity η (mPa·sec) of the liquid being processed, the magnitude d of the gap and the circumferential speed ω (m/sec) of the inner cylinder satisfies any one of the following relations: (1) when η≦20, d≦5/ω; (2) when 20<η≦50, d≦10/ω; (3) when 50<η100, d≦20/ω; and (4) 100<η.

According to the fifth aspect, in the liquid being processed flowing in the gap between the inner cylinder and the outer cylinder, a laminar flow state without any vortex flow is formed, and hence a uniform shear force is exerted to the liquid being processed, so that microcapsules each having a sharp particle diameter distribution can be produced.

As described above, according to the method and apparatus for emulsification of the present invention, the viscosity η of the liquid being processed, the magnitude d of the gap between the inner cylinder and the outer cylinder, and the circumferential speed ω of the inner cylinder are made to satisfy one of the predetermined relations, so that in the liquid being processed in the gap, a laminar flow state without any vortex flow is formed. Accordingly, a uniform shear force is exerted to the liquid being processed, and hence there can be produced an emulsified liquid in which the liquid droplets are dispersed in a uniform size, and by use of the emulsified liquid, there can be produced a microcapsule having a sharp particle diameter distribution.

### BRIEF DESCRIPTION OF THE DRAWINGS

FIG. 1 is an overall block diagram illustrating a production apparatus of microcapsules to which an apparatus for emulsification involved in the present invention is applied;

FIG. 2 is an oblique perspective view illustrating the configuration of the apparatus for emulsification; and

FIG. 3 is a graph explaining the relations (1) to (4).

### DETAILED DESCRIPTION OF THE PREFERRED EMBODIMENTS

Now, detailed description will be made below on the preferred embodiments of the method and apparatus for emulsification involved in the present invention with reference to the accompanying drawings.

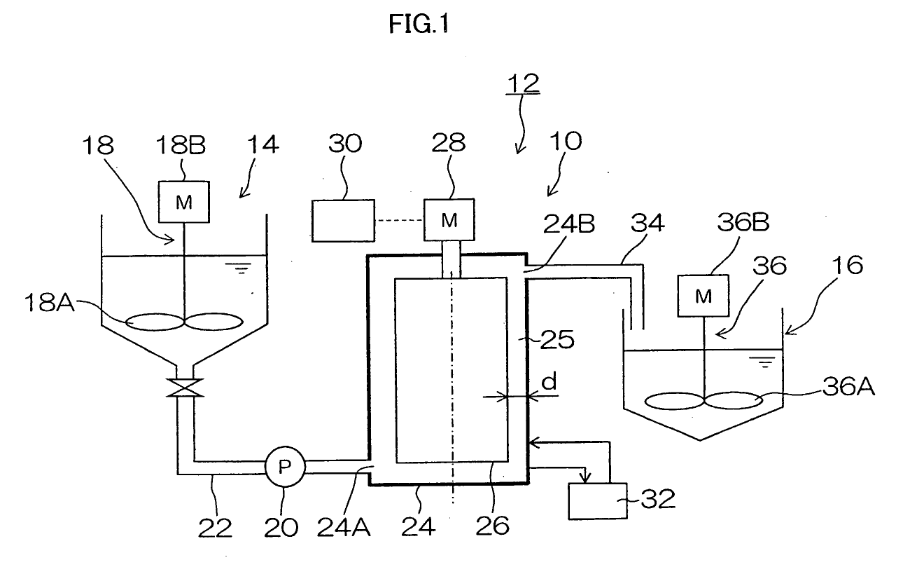

FIG. 1 is an overall block diagram illustrating a production apparatus of microcapsules in which an apparatus for emulsification involved in the present invention is used.

As shown in FIG. 1, the production apparatus 12 is mainly constituted with a preliminary emulsification vessel 14, an apparatus for emulsification 10, and a capsulation vessel 16.

Into the preliminary emulsification vessel 14, the aqueous phase and the oil phase are respectively fed with an appropriate ratio. The preliminary emulsification vessel 14 is provided with a stirrer 18 including stirring blades 18A and a motor 18B; by rotating the stirring blades 18A with a motor 18B, the aqueous phase and the oil phase are mixed together and thus a preliminary emulsified liquid (hereinafter referred to as a liquid being processed) is prepared.

The liquid being processed in the preliminary emulsification vessel 14 is transferred to the apparatus 10 for emulsification through a pipe 22 by driving a pump 20.

The apparatus 10 for emulsification is mainly constituted with an outer cylinder 24 and an inner cylinder 26 arranged in the outer cylinder 24. The outer cylinder 24 and the inner cylinder 26 are coaxially arranged in a superposed manner in such a way that the central axes of the respective cylinders are vertical. Consequently, the gap 25 between the outer cylinder 26 and the inner cylinder 24 is formed so as to be constant anywhere in the gap. The magnitude d of the gap 25 is determined according to the size of the microcapsule to be produced in such a way that the magnitude d of the gap 25 falls, for example, within a range of 0.01 to 2 mm and is constant. Additionally, the axial direction length of the inner cylinder 26 is made to be two or more times the magnitude d of the gap 25.

The outer cylinder 24 is fixed to a frame not shown in the figure, and the inner cylinder 26 is supported by the outer cylinder 24 in a freely rotatable manner. A motor 28 is connected to the upper end of the inner cylinder 26, and by driving the motor 28, the inner cylinder 26 is made to rotate. The rotational speed (circumferential speed) of the inner cylinder 26 is controlled by a controller 30. The controller 30 controls the circumferential speed ω of the inner cylinder 26 according to the beforehand measured viscosity η (mPa·sec) of the liquid being processed, the magnitude d (mm) of the gap 25, and the desired average particle size. More specifically, the circumferential speed ω (m/sec) of the inner cylinder 26 is controlled in such a way that the viscosity ω of the liquid being processed, the magnitude d of the gap 25, and the circumferential speed ω satisfy any one of the following relations:
(1) When η≦20, d≦5/ω;
(2) When 20<η≦50, d≦10/ω;
(3) When 50<η≦100, d≦20/ω;
(4) When 100<η (d and ω arbitrary).

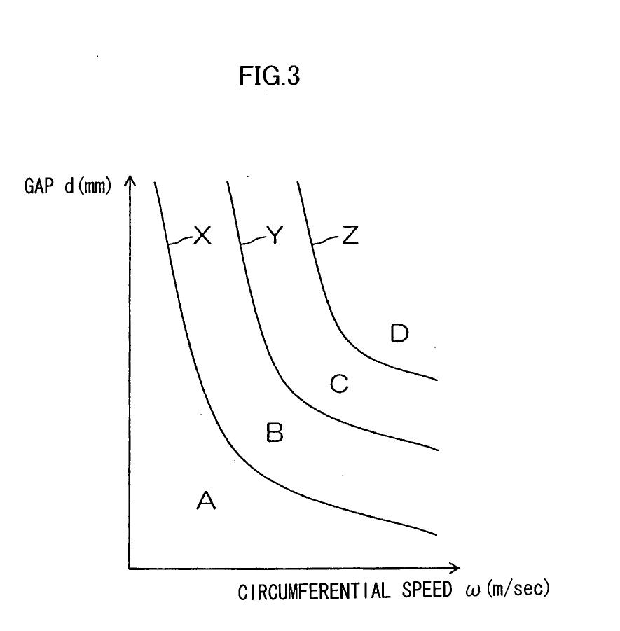

FIG. 3 is a graph explaining the relations (1) to (4). In FIG. 3, the curves X, Y and Z are respectively the curves of d=5/ω, d=10/ω and d=20/ω. Additionally, the region A, B, C and D are the regions segmented by the curves X, Y and Z.

When η≦20, ω is controlled such that d and co belong to the region beneath the curve X (namely, the region A) (relation (1)).

When 20<η≦50, ω is controlled such that d and co belong to the region beneath the curve Y (namely, the regions A and B) (relation (2)).

When 50<η≦100, ω is controlled such that d and ω belong to the region beneath the curve Z (namely, the regions A, B and C) (relation (3)).

When 100<η, d and ω are optional such that d and c) may belong to any one of the regions A, B, C and D (relation (4)).

Incidentally, in the above relations (1) to (4), as the viscosity η of the liquid being processed, the viscosity corresponding to the shear velocity in the gap 25 is used.

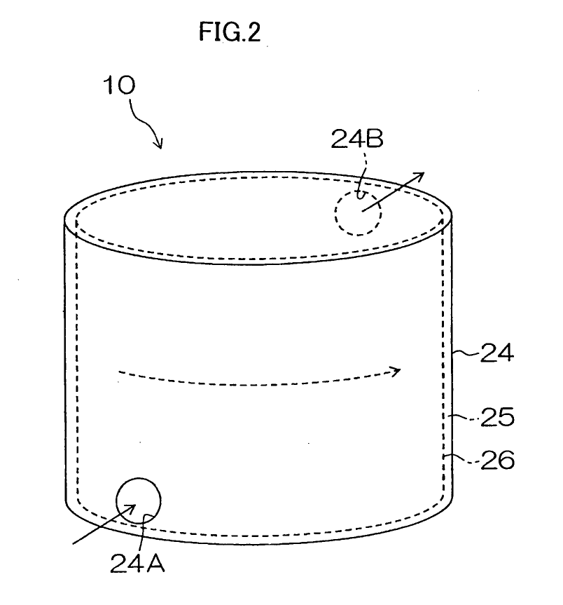

The outer cylinder 24 in FIG. 1 is provided with an inlet opening 24A formed on the bottom portion of the side surface thereof, and the pipe 22 is connected to the inlet opening 24A. Additionally, the outer cylinder 24 is provided with an outlet opening 24B formed on the top portion of the side surface thereof, and the outlet opening 24B is connected to the capsulation vessel 16 through the pipe 34. Consequently, when the liquid being processed is fed from the inlet opening 24A into the interior of the outer cylinder 24, the liquid being processed goes up in the gap 25 between the outer cylinder 24 and the inner cylinder 26, and then discharged from the outlet opening 24B. It is preferable that the inlet opening 24A is formed in such a way that the liquid being processed is fed, as shown in FIG. 2, along the direction tangential to the outer cylinder 24. Similarly, it is preferable that the outlet opening 24B is formed in such a way that the liquid being processed is discharged along the direction tangential to the outer cylinder 24.

As shown in FIG. 1, a chiller 32 is connected to the outer cylinder 24, and a fluid (for example, cooling water) with a temperature controlled by the chiller 32 is fed into the jacket of the outer cylinder 24. Accordingly, the liquid being processed passing through the gap 25 between the outer cylinder 24 and the inner cylinder 26 is controlled to have a predetermined temperature (for example 30° C.).

In the apparatus 10 for emulsification, constituted as described above, the rotation of the inner cylinder 26 gives the shear force to the liquid being processed flowing in the gap 25 between the inner cylinder 26 and the outer cylinder 24, and the liquid being processed is thereby emulsified. The emulsified liquid is discharged from the outlet opening 24B, and transferred to the capsulation vessel 16 through the pipe 34.

The capsulation vessel 16 is provided with a stirrer 36 including stirring blades 36A and a motor 36B. The emulsified liquid fed into the capsulation vessel 16 is subjected to the capsulation process including heating and evacuation of air, and thus a microcapsule is produced.

Now, description will be made below on the operation of the apparatus 10 for emulsification constituted as described above.

In the apparatus 10 for emulsification, the circumferential speed ω of the inner cylinder 26 is controlled according to the viscosity η of the liquid being processed and the magnitude d of the gap 25 in such a way that any one of the above described relations (1) to (4) is satisfied. Consequently, in the liquid being processed flowing in the gap 25, a laminar flow state without any vortex flow is formed. Accordingly, a microscopically uniform shear force is exerted to the liquid being processed, so that there can be obtained an emulsified liquid having a desired average particle diameter and a sharp particle diameter distribution. In this way, there can be obtained a microcapsule having a desired average particle diameter and a sharp particle diameter distribution.

The microcapsule thus obtained has been produced accurately in relation to the desired average particle diameter, and the particle diameter distribution is sharp, so that the microcapsule is suitable for use in various fields including ink, agricultural chemicals, pharmaceuticals, cosmetics and the like. Additionally, the microcapsule is suitable for heat sensitive recording materials and pressure sensitive recording materials which are produced by applying the microcapsule on sheet like supports. Furthermore, the microcapsule is suitable for electronic paper (also referred to as digital paper), paper displays, or drug delivery systems in which microcapsules are used. In particular, when the microcapsule is applied to pressure sensitive recording materials and heat sensitive recording materials, color can always be developed at a constant pressure and at a constant temperature by making the particle size distribution of the microcapsules sharp. Additionally, when the microcapsule is applied to electronic paper and paper displays, displayed images can be made clear by making the particle size distribution of the microcapsules sharp. Furthermore, in the case of drug delivery systems, a medicine enclosed in the microcapsules can be supplied accurately to the desired affected parts by making the particle diameter distribution of the microcapsule sharp.

Additionally, in the above described embodiment, the outer cylinder 24 is fixed and the inner cylinder 26 is rotated; however, the present invention is not limited to the above described embodiment. For example, the inner cylinder 26 may be fixed and the outer cylinder 24 may be rotated. In this case, no vortex flow is formed in the gap 25 independently of the relation between the viscosity η of the liquid being processed, the magnitude d of the gap, and the circumferential speed ω of the inner cylinder 26, and hence a laminar flow state without any vortex flow can always be formed in the liquid being processed in the gap 25. Alternatively, it may be arranged that both of the inner cylinder 26 and the outer cylinder 24 are rotated in such a way that the circumferential speed of the outer cylinder 24 is made faster than the circumferential speed of the inner cylinder 26. Also in this case, a laminar flow state without any vortex flow is formed in the liquid being processed in the gap 25.

### EXAMPLES

### Example 1

There were prepared an aqueous phase in which water was the main solvent and 5% of gelatin was contained, and an oil phase in which acetyl acetate was the main solvent, and an oil and a wall material were contained. Then, the aqueous phase and the oil phase were preliminarily emulsified under the preliminary emulsification conditions described below. In the next place, the preliminarily emulsified liquid was emulsified under the emulsification conditions (corresponding to the conditional expression (1); η=15 mPa·sec, d=0.1 mm, and ω=30 m/sec) described below, further capsulated under the capsulation conditions described below, and thus a microcapsule was produced. The produced microcapsules were photographed with a SEM (scanning electron microscope), and the particle diameter distribution was examined by means of an image processing analyzer, confirming the formation of a microcapsule having a sharp particle diameter distribution with an average particle diameter of 0.5 μm and a span value of 0.5. Here, the span value is the quantity expressed as ε=(d₉₀−d₁₀)/d₅₀ where ε designates the span value, d₉₀ designates the 90% cumulative diameter (based on volume), d₅₀ designates the 50% cumulative diameter (based on volume), and d₁₀ designates the 10% cumulative diameter (based on volume). The viscosity measurement was conducted by use of a double cylindrical rotational viscometer Roto Visco RV1 manufactured by Haake Inc.

<Preliminary Emulsification Conditions>

The preparation quantity: 3 kg; the aqueous phase/oil phase mixing weight ratio: 2/1; the stirrer: φ50 mm propeller blade; the stirring rotation number: 500 rpm; the stirring time: 1 min; the maintained temperature: 40° C.

<Emulsification Conditions>

The liquid transfer flow rate: 190 g/min; the diameter of the inner cylinder: 100.8 mm; the length of the inner cylinder: 100 mm; the diameter of the outer cylinder: 101.0 mm; the length of the outer cylinder: 110 mm; the number of rotation of the inner cylinder: 5,684 rpm; the cooling temperature of the outer cylinder: 0° C.; the viscosity corresponding to the shear speed in the gap: 15 mPa·sec.

<Capsulation Conditions>

The preparation quantity: 500 g; the stirrer: +30 mm propeller blade; the stirring rotation number: 300 rpm; the stirring time: 3 hr; the maintained temperature: 40° C.

### Example 2

A microcapsule was produced under the emulsification conditions (corresponding to the conditional expression (1); η=15 mPa·sec, d=0.05 mm, and ω=50 m/sec) the same as those in Example 1 except that in the emulsification conditions of Example 1, the diameter of the inner cylinder was altered to 100.9 mm, the number of rotation of the inner cylinder was altered to 9,464 rpm, and the liquid transfer flow rate was altered to 95 g/min. Consequently, there was obtained a microcapsule having a sharp particle diameter distribution with the average particle diameter of 0.3 μm and the span value of 0.5.

### Example 3

A microcapsule was produced under the emulsification conditions (corresponding to the conditional expression (1); η=15 mPa·sec, d=0.4 mm, and ω=10 m/sec) the same as those in Example 1 except that in the emulsification conditions of Example 1, the diameter of the inner cylinder was altered to 100.2 mm, the number of rotation of the inner cylinder was altered to 1,906 rpm, and the liquid transfer flow rate was altered to 758 g/min. Consequently, there was obtained a microcapsule having a sharp particle diameter distribution with the average particle diameter of 1.0 μm and the span value of 0.5.

### Example 4

A microcapsule was produced under the emulsification conditions (corresponding to the conditional expression (2); η=40 mPa·sec, d=0.2 mm, and ω=30 m/sec) the same as those in Example 1 except that in the emulsification conditions in Example 1, the gelatin concentration in the aqueous phase was altered to 7%, and consequently, the viscosity corresponding to the shear speed in the gap was 40 mPa·sec, and additionally, the diameter of the inner cylinder was altered to 100.6 mm, the number of rotation of the inner cylinder was altered to 5,695 rpm, and the liquid transfer flow rate was altered to 380 g/min. Consequently, there was obtained a microcapsule having a sharp particle diameter distribution with the average particle diameter of 0.5 μm and the span value of 0.5.

### Example 5

A microcapsule was produced under the emulsification conditions (corresponding to the conditional expression (3); η=80 mPa·sec, d=0.4 mm, and ω=30 m/sec) the same as those in Example 1 except that in the emulsification conditions in Example 1, the gelatin concentration in the aqueous phase was altered to 10%, and consequently, the viscosity corresponding to the shear speed in the gap was 80 mPa·sec, and additionally, the diameter of the inner cylinder was altered to 100.2 mm, the number of rotation of the inner cylinder was altered to 5,718 rpm, and the liquid transfer flow rate was altered to 758 g/min. Consequently, there was obtained a microcapsule having a sharp particle diameter distribution with the average particle diameter of 0.5 μm and the span value of 0.5.

### Example 6

A microcapsule was produced under the emulsification conditions (corresponding to the conditional expression (4); η=120 mPa·sec) the same as those in Example 1 except that in the emulsification conditions in Example 1, the gelatin concentration in the aqueous phase was altered to 15%, and consequently, the viscosity corresponding to the shear speed in the gap was 120 mPa·sec, and additionally, the diameter of the inner cylinder was altered to 99.8 mm, the number of rotation of the inner cylinder was altered to 9,568 rpm, and the liquid transfer flow rate was altered to 1,135 g/min. Consequently, there was obtained a microcapsule having a sharp particle diameter distribution with the average particle diameter of 0.5 μm and the span value of 0.5.

### Comparative Example 1

A microcapsule was produced under the emulsification conditions (η=15 mPa·sec, d=0.5 mm, and ω=50 m/sec) the same as those in Example 1 except that as compared to Example 1, the diameter of the inner cylinder was altered to 100.0 mm, the number of rotation of the inner cylinder was altered to 9,549 rpm, and the liquid transfer flow rate was altered to 947 g/min. Consequently, there was obtained a microcapsule having a broad particle diameter distribution with the average particle diameter of 0.5 μm and the span value of 0.9.

### Comparative Example 2

As compared to Example 1, the preliminary emulsification conditions and the capsulation conditions were not altered, but merely the emulsification conditions were altered. More specifically, the emulsification was carried out with a φ30 mm dissolver, and a microcapsule was produced under the emulsification conditions such that the preparation quantity was 500 g, the number of rotation was 13,000 rpm and the emulsification time was 10 min. Consequently, there was obtained a microcapsule having a broad particle diameter distribution with the average particle diameter of 0.5 μm and the span value of 1.0.

### Comparative Example 3

A microcapsule was produced under the emulsification conditions (η=40 mPa·sec, d=0.6 mm, and ω=40 m/sec) the same as those in Example 4 except that as compared to Example 4, the diameter of the inner cylinder was altered to 99.8 mm, the number of rotation of the inner cylinder was altered to 7,655 rpm, and the liquid transfer flow rate was altered to 1,135 g/min. Consequently, there was obtained a microcapsule having a broad particle diameter distribution with the average particle diameter of 0.5 μm and the span value of 0.9.

### Comparative Example 4

As compared to Example 4, the preliminary emulsification conditions and the capsulation conditions were not altered, but merely the emulsification conditions were altered. More specifically, the emulsification was carried out with a φ30 mm dissolver, and a microcapsule was produced under the emulsification conditions such that the preparation quantity was 500 g, the number of rotation was 13,000 rpm and the emulsification time was 7 min. Consequently, there was obtained a microcapsule having a broad particle diameter distribution with the average particle diameter of 0.5 μm and the span value of 1.0.

### Comparative Example 5

A microcapsule was produced under the emulsification conditions (η=80 mPa·sec, d=1.0 mm, and ω=40 m/sec) the same as those in Example 5 except that as compared to Example 5, the diameter of the inner cylinder was altered to 99.0 mm, the number of rotation of the inner cylinder was altered to 7,717 rpm, and the liquid transfer flow rate was altered to 1,884 g/min. Consequently, there was obtained a microcapsule having a broad particle diameter distribution with the average particle diameter of 0.5 μm and the span value of 0.9.

### Comparative Example 6

As compared to Example 5, the preliminary emulsification conditions and the capsulation conditions were not altered, but merely the emulsification conditions were altered. More specifically, the emulsification was carried out with a φ30 mm dissolver, and a microcapsule was produced under the emulsification conditions such that the preparation quantity was 500 g, the number of rotation was 13,000 rpm and the emulsification time was 3 min. Consequently, there was obtained a microcapsule having a broad particle diameter distribution with the average particle diameter of 0.5 μm and the span value of 1.0.

### Comparative Example 7

As compared to Example 6, the preliminary emulsification conditions and the capsulation conditions were not altered, but merely the emulsification conditions were altered. More specifically, the emulsification was carried out with a φ30 mm dissolver, and a microcapsule was produced under the emulsification conditions such that the preparation quantity was 500 g, the number of rotation was 13,000 rpm and the emulsification time was 1 min. Consequently, there was obtained a microcapsule having a broad particle diameter distribution with the average particle diameter of 0.5 μm and the span value of 1.0.

<Production of a Heat Sensitive Recording Material>

Now, description will be made below on the example in which a heat sensitive recording materials is produced by preparing a microcapsule for use in the heat sensitive recording material by means of the method and apparatus for emulsification of the present invention.

The heat sensitive recording layer of a heat sensitive recording material contains microcapsules enclosing as a coloring component a diazonium salt compound or an electron donating dye precursor; these microcapsules contain as a developer a coupler or an electron accepting compound in conformity with the coloring component. The developer is converted into particulates through emulsification-dispersion or solid dispersion. A heat sensitive recording layer is formed by applying to a support a mixture, prepared as described below, of a microcapsule dispersion liquid and a dispersion liquid of a developer.

<Production of a Microcapsule>

The production of a microcapsule including a diazonium salt compound or an electron donating dye precursor is carried out as follows: at the beginning, there are prepared an oil phase solution containing a diazonium salt compound or an electron donating dye precursor and a microcapsule wall material, and an aqueous phase solution; and these solutions are subjected to emulsification-dispersion by use of the apparatus for emulsification involved in the present invention. Then, the emulsified dispersion liquid thus obtained is used for microcapsulation, and consequently, a microcapsule is obtained. In this case, it is preferable that an aqueous solution containing a water soluble polymer compound having surface activity is added to the emulsified dispersion liquid, and then microcapsulation is carried out.

As the above described aqueous phase solution, there is used an aqueous solution containing a water soluble polymer compound having at least surface activity. Examples of the water soluble polymer compound include polyvinyl alcohol and modified products thereof, polyacrylic acid amide and the derivatives thereof, ethylene-vinyl acetate copolymer, styrene-maleic anhydride copolymer, ethylene-maleic anhydride copolymer, isobutylene maleic anhydride copolymer, polyvinylpyrrolidone, ethylene-acrylic acid copolymer, vinyl acetate-acrylic acid copolymer, carboxymethylcellulose, methylcellulose, casein, gelatin, starch derivatives, gum arabic and sodium alginate. It is preferable that these water soluble polymers have no or low reactivity with isocyanate compounds; thus, for example, those compounds having reactive amino groups in the molecular chain such as gelatin are required to beforehand lose the reactivity concerned.

In the step of microcapsulation, it is preferable that to an emulsified dispersion liquid, furthermore an aqueous solution containing a water soluble polymer compound having at least surface activity is added, and then a microcapsule wall material is made to react to form microcapsule walls. This addition of the aqueous solution can prevent the coagulation of the microcapsule particles taking place rarely. It is appropriate that the aqueous solution for addition is added in such a way that the solid content concentration of the microcapsule dispersion liquid after the reaction comes to be 5 to 50 mass %, preferably 10 to 40 mass %. Incidentally, in what follows, the aqueous phase liquid added to the oil phase liquid at the time of emulsification and dispersion is referred to as the first aqueous phase liquid, and the aqueous phase liquid added to the emulsified dispersion liquid at the time of microcapsulation is referred to as the second aqueous liquid, as the case may be.

As the water soluble polymer compound having at least surface activity added to the second aqueous liquid, the water soluble polymer compounds contained in the first aqueous liquid are used similarly. It is desirable that the concentration of the water soluble polymer compound contained in the second aqueous phase liquid is 1 to 20 mass %, preferably 2 to 10 mass %.

On the other hand, the preparation of the above described oil phase liquid is carried out in such a way that a diazonium salt compound or an electron donating dye precursor, a microcapsule wall material, and various additives are dissolved according to need in an organic solvent which is scarcely soluble or insoluble in water.

Examples of the organic solvents include low boiling point auxiliary solvents such as acetates, methylene chloride and, cyclohexane and/or phosphates, phthalates, acrylates, methacrylates, and other carboxylates, fatty amides; alkylated biphenyls, alkylated terphenyls, alkylated naphthalenes, diarylethanes, chlorinated paraffin, alcohol solvents, phenol solvents, ether solvents, monoolefin solvents and epoxy solvents. Specific examples of the organic solvents include high boiling point oils such as tricresyl phosphate, trioctyl phosphate, octyl diphenyl phosphate, tricyclohexyl phosphate, dibutyl phthalate, dioctyl phthalate, dilauryl phthalate, dicyclohexyl phthalate, butyl oleate, diethyleneglycol dibenzoate, dioctyl sebacate, dibutyl sebacate, dioctyl adipate, trioctyl trimellitate, acetyltriethyl citrate, octyl maleate, dibutyl maleate, isoamyl biphenyl, chlorinated paraffin, diisopropyl naphthalene, 1,1′-ditolylethane, 2,4-di-tert-amylphenol, N,N-dibutyl-2-butoxy-5-tert-octyl aniline, 2-ethylhexyl hydroxybenzoate, and polyethylene glycol; among these, particularly preferable are alcohol based solvents, phosphate based solvents, carboxylate based solvents, alkylated biphenyls, alkylated terphenyls, alkylated naphthalenes, and diarylethanes. Furthermore, carbonization preventing agents such as hindered phenols and hindered amines may be added to the above described high boiling point oils. Additionally, as oils, oils having unsaturated fatty acids are particularly preferable, and α-methylstyrene dimer and the like can be cited. As α-methylstyrene dimmer, MSD 100 (brand name) manufactured by Mitsui Toatsu Chemicals, Inc. and the like are available.

The above described diazonium salt compounds are the compounds represented by the following formula, and develop colors upon heating through causing coupling reaction with couplers, and additionally are compounds to be decomposed by light. The maximum absorption wavelengths of these compounds can be controlled by varying the types and positions of the substituents in the “Ar” portion.

Ar—N₂⁺X⁻ (In this formula, Ar designates the aromatic portion and X− designates an acid anion.)

Specific examples of the diazoniums forming salts include 4-(p-tolylthio)-2,5-dibutoxybenzene diazonium, 4-(4-chlorophenylthio)-2,5-dibutoxybenzene diazonium, 4-(N,N-dimethylamino)benzene diazonium, 4-(N,N-diethylamino)benzene diazonium, 4-(N,N-dipropylamino)benzene diazonium, 4-(N-methyl-N-benzylamino)benzene diazonium, 4-(N,N-dibenzylamino)benzene diazonium, 4-(N-ethyl-N-hydroxyethylamino)benzene diazonium, 4-(N,N-diethylamino)-3-methoxybenzene diazonium, 4-(N,N-dimethylamino)-2-methoxybenzene diazonium, 4-(N-benzoylamino)-2,5-diethoxybenzene diazonium, 4-morpholino-2,5-dibutoxybenzene diazonium, 4-anilinobenzene diazonium, 4-[N-(4-methoxybenzoyl)amino]-2,5-diethoxybenzene diazonium, 4-pyrrolidino-3-ethylbenzene diazonium, 4-[N-(1-methyl-2-(4-methoxyphenoxy)ethyl)-N-hexylamino]-2-hexyloxybenzene diazonium, 4-[N-(2-(4-methoxyphenoxy)ethyl)-N-hexylamino]-2-hexyloxybenzene diazonium, 2-(1-ethylpropyloxy)-4-[di-(di-n-butylaminocarbonylmethyl)amino]benzene diazonium, and 2-benzylsulfonyl-4-[N-methyl-N-(2-octanoyloxyethyl)]aminobenzene diazonium.

As the couplers to couple with diazo compounds to form dyes, any compound can be used as far as the compound forms dyes by coupling with diazo compounds in a basic atmosphere and/or a neutral atmosphere. All the so-called 4-equivalent couplers for use in the silver halide photographic materials can be used as couplers. These can be selected according to the intended hue.

Specific example of the couplers include resorcin, phloroglucin, 2,3-dihydroxynaphthalene, sodium 2,3-dihydroxynaphthalene-6-sulfonate, 1-hydroxy-2-naphthoic acid morpholinopropyl amide, sodium 2-hydroxy-3-naphthalenesulfonate, 2-hydroxy-3-naphthalenesulfonic acid anilide, 2-hydroxy-3-naphthalenesulfonic acid morpholinopropyl amide, 2-hydroxy-3-naphthalenesulfonic acid-2-ethylhexyloxypropyl amide, 2-hydroxy-3-naphthalenesulfonic acid-2-ethylhexyl amide, 5-acetamide-1-naphthol, sodium 1-hydroxy-8-acetamidenaphthalene-3,6-disulfonate, 1-hydroxy-8-acetamidenaphthalene-3,6-disulfonic acid dianilide, 1,5-dihydroxynaphthalene, 2-hydroxy-3-naphthoic acid morpholinopropylamide, 2-hydroxy-3-naphthoic acid octylamide, 2-hydroxy-3-naphthoic acid anilide, 5,5-dimethyl-1,3-cyclohexanedione, 1,3-cyclopentanedione, 5-(2-n-tetradecyloxyphenyl)-1,3-cyclohexanedione, 5-phenyl-4-methoxycarbonyl-1,3-cyclohexanedione, 5-(2,5-di-n-octyloxyphenyl)-1,3-cyclohexanedione, N,N′-dicyclohexylbarbituric acid, N,N′-di-n-dodecylbarbituric acid, N-n-octyl-N′-n-octadecylbarbituric acid, N-phenyl-N′-(2,5-di-n-octyloxyphenyl)barbituric acid, N,N′-bis(octadecyloxycarbonylmethyl)barbituric acid, 1-phenyl-3-methyl-5-pyrazolone, 1-(2,4,6-trichlorophenyl)-3-anilino-5-pyrazolone, 1-(2,4,6-trichlorophenyl)-3-benzamido-5-pyrazolone, 6-hydroxy-4-methyl-3-cyano-1-(2-ethylhexyl)-2-pyridone, 2,4-bis(benzoylacetamido)toluene, 1,3-bis(pivaloylacetamidomethyl)benzene, benzoylacetonitrile, thenoylacetonitrile, acetoacetanilide, benzoylacetanilide, pivaloylacetanilide, 2-chloro-5-(N-n-butylsulfamoyl)-1-pivaloylacetamidobenzene, 1-(2-ethylhexyloxypropyl)-3-cyano-4-methyl-6-hydroxy-1,2-dihydropyridine-2-one, 1-(dodecyloxypropyl)-3-acetyl-4-methyl-6-hydroxy-1,2-dihydropyridine-2-one, and 1-(4-n-octyloxyphenyl)-3-tert-butyl-5-aminopyrazole. Detailed descriptions of the couplers are found in Japanese Patent Application Publication Nos. 4-201483, 7-223367, 7-223368, and 7-323660, and in Japanese Patent Application Nos. 5-278608, 5-297024, 6-18669, 6-18670, 7-316280, 8-027095, 8-027096, 8-030799, 8-12610, 8-132394, 8-358755, 8-358756, 9-069990 and the like.

Examples of the electron donating dye precursors enclosed in microcapsules include triarylmethane based compounds, diphenylmethane based compounds, thiazine based compounds, xanthene based compounds and spiropyran based compounds; among these, the triarylmethane based compounds and the xanthene based compounds are particularly useful because these compounds lead to high color developing densities. Examples of a part of these compounds include 3,3-bis(p-dimethylaminophenyl)-6-dimethylaminophthalide (namely, crystalviolet lactone), 3,3-bis(p-diemthylamino)phthalide, 3-(p-dimethylaminophenyl)-3-(1,3-dimethylindol-3-yl)phthalide, 3-(p-dimethylaminophenyl)-3-(2-methylindol-3-yl)phthalide, 3-(o-methyl-p-diethylaminophenyl)-3-(2-methylindol-3-yl)phthalide, 4,4′-bis(dimethylamino)benzhydrinbenzyl ether, N-halophenyl leucoauramines, N-2,4,5-trichlorophenyl luecoauramine, rhodamine B anilinolactam, rhodamine (p-nitroanilino)lactam, rhodamine-B-(p-chloroanilino)lactam, 2-benzylamino-6-diethylaminofluorane, 2-anilino-6-diethylaminofluorane, 2-anilino-3-methyl-6-diethylaminofluorane, 2-anilino-3-methyl-6-cyclohexylmethylaminofluorane, 2-anilino-3-methyl-6-isoamylethylaminofluorane, 2-(o-chloroanilino)-6-diethylaminofluorane, 2-octylamino-6-diethylaminofluorane, 2-ethoxyethylamino-3-chloro-2-diethylaminofluorane, 2-anilino-3-chloro-6-diethylaminofluorane, benzoyl leucomethylene blue, p-nitrobenzyl leucoemtylene blue, 3-methyl-spiro-dinaphthopyran, 3-ethyl-spiro-dinaphthopyran, 3,3′-dichloro-spiro-dinaphthopyran, 3-benzylspirodinaphthopyran, and 3-propyl-spiro-dibenzopyran.

Examples of the electron accepting compounds include phenol derivatives, salicylic acid derivatives, and hydroxybenzoic acid esters. Particularly, bisphenols and hydroxybenzoic acid esters are preferable. Examples of a part of these compounds include 2,2-bis(p-hydroxyphenyl)propane (namely, bisphenol A), 4,4′-(p-phenylenediisopropylidene)diphenol (namely, bisphenol P), 2,2-bis(p-hydroxyphenyl)pentane, 2,2-bis(p-hydroxyphenyl)ethane, 2,2-bis(p-hydroxyphenyl)butane, 2,2-bis(4′-hyroxy-3′,5′-dichlorophenyl)propane, 1,1-(p-hydroxyphenyl)cyclohexane, 1,1-(p-hydroxyphenyl)propane, 1,1-(p-hydroxyphenyl)pentane, 1,1-(p-hydroxyphenyl)-2-ethylhexane, 3,5-di(α-methylbenzyl)salicylic acid and polyvalent metal salts thereof, 3,5-di(tert-butyl)salicylic acid and polyvalent metal salts thereof, 3-α,α-dimethylbenzylsalicylic acid and polyvalent metal salts thereof, butyl p-hydroxybenzoate, benzyl p-hydroxybenzoate, 2-ethylhexyl p-hydroxybenzoate, p-phenylphenol and p-cumylphenol.

As the sensitizers, preferable are low melting point organic compounds which have an appropriate number of polar groups and an appropriate number of aromatic groups within a molecule. Examples of such compounds include benzyl p-benzyloxybenzoate, α-naphthyl benzyl ether, β-naphthyl benzyl ether, β-naphthoic acid phenyl ester, α-hydroxy-β-naphthoic acid phenyl ester, β-naphthol-(p-chlorobenzyl) ether, 1,4-butanediol phenyl ether, 1,4-butanediol-p-methylphenyl ether, 1,4-butanediol-p-ethylphenyl ether, 1,4-butanediol-m-methylphenyl ether, 1-phenoxy-2-(p-tolyloxy)ethane, 1-phenoxy-2-(p-ethylphenoxy)ethane, 1-phenoxy-2-(p-chlorophenoxy)ethane, and p-benzylbiphenyl.

The microcapsule wall materials are preferably polymer substances, and specific examples of such polymer substances include polyurethane resin, polyurea resin, polyamide resin, polyester resin, polycarbonate resin, aminoaldehyde resin, melamine resin, polystyrene resin, styrene-acrylate copolymer resin, styrene-methacrylate copolymer resin, gelatin and polyvinyl alcohol. Among these substances, polyurethane polyurea resin is a particularly preferable wall material. Those microcapsules which have a wall film composed of polyurethane polyurea resin are produced as follows: a microcapsule wall precursor such as a multivalent isocyanate or the like is mixed in a core material to be capsulated, and is emulsified and dispersed in an aqueous solution of a water soluble polymer such as polyvinyl alcohol, and the temperature is elevated so that polymer formation reaction may be made to take place on the interface of the oil droplets.

In this connection, a part of the specific examples of the multivalent isocyanate compounds will be described below. Such examples include diisocyanates such as m-phenylene diisocyanate, p-phenylene diisocyanate, 2,6-trilene diisocyanate, 2,4-trilene diisocyanate, naphthalene-1,4-diisocyanate, diphenylmethane-4,4′-diisocyanate, 3,3′-diphenylmethane-4,4′-diisocyanate, xylene-1,4-diisocyanate, 4,4′-diphenylpropane diisocyanate, trimethylene diisocyanate, hexamethylene diisocyanate, propylene-1,2-diisocyanate, butylenes-1,2-diisocyanate, cyclohexylene-1,2-diisocyanate and cyclohexylene-1,4-diisocyanate; triisocyanate such as 4,4′,4″-triphenylmethane triisocyanate and toluene-2,4,6-triioscyanate; tetraisocyanates such as 4,4′-dimethylphenylmethane-2,2′,5,5′-tetraisocyanate; and isocyanate prepolymers such as an adduct between hexamethylene diisocyanate and trimethylolpropane, an adduct between 2,4-trilene diisocyanate and trimethylolpropane, an adduct between xylene diisocyanate and trimethylolpropane, and an adduct between trilene diisocyanate and hexanetriol. According to need, two or more of these compounds can be used simultaneously. Among these compounds, particularly preferable are the compounds having three or more isocyanate groups in a molecule.

Additionally, the above described couplers or the electron accepting compounds to be contained in the heat sensitive recording layer of a heat sensitive recording material are subjected to emulsification-dispersion or solid dispersion for converting to particulates; however, it is preferable that the couplers and electron accepting compounds are used as subjected to solid dispersion. The heat sensitive recording material of the present invention can be produced in the following way: a microcapsule dispersion liquid prepared as described above and a dispersion liquid, prepared as described above, of a coupler or an electron accepting compound are mixed together, the mixture thus obtained is applied onto a support, and thus a heat sensitive recording layer is formed.

1. A method for emulsification in which a liquid being processed comprising an aqueous phase and an oil phase is made to pass through a gap between an outer cylinder and an inner cylinder arranged coaxially in said outer cylinder, and said liquid being processed is emulsified by rotating at least one of said outer cylinder and said inner cylinder, comprising:
forming a laminar flow state without any vortex flow in the liquid being processed which is passing through said gap.

2. The method for emulsification according to claim 1, wherein:
the magnitude d (mm) of said gap falls within the range of 0.01 to 2 mm and is constant;
the axial direction length of said inner cylinder is two or more times the magnitude d of said gap; and
when said outer cylinder is fixed and said inner cylinder is rotated at a circumferential speed of ω (m/sec), the relation between the viscosity η (mPa·sec) of said liquid being processed, said circumferential speed ω, and the magnitude d of said gap satisfies any one of the following relations:
(1) When η≦20, d≦5/ω;
(2) When 20<η≦50, d≦10/ω);
(3) When 50<η≦100, d≦20/ω;
(4) When 100<η.

3. An emulsified liquid produced by means of the method for emulsification of claim 1.

4. An emulsified liquid produced by means of the method for emulsification of claim 2.

5. A microcapsule produced by use of the emulsified liquid of claim 3.

6. A microcapsule produced by use of the emulsified liquid of claim 4.

7. An apparatus for emulsification, comprising:
an outer cylinder;
an inner cylinder arranged coaxially in said outer cylinder;
a rotation driving device for rotating said inner cylinder; and
a feeding device for feeding a liquid being processed comprising an aqueous phase and an oil phase into a gap between said inner cylinder and said outer cylinder, wherein:
when the magnitude d (mm) of said gap falls within the range of 0.01 to 2 mm and is constant, and the axial direction length of said inner cylinder is two or more times the magnitude d of said gap, the apparatus for emulsification comprises a controller for controlling the circumferential speed ω of said inner cylinder in such a way that the relation between the viscosity η (mPa·sec) of said liquid being processed, the magnitude d of said gap, and the circumferential speed ω (m/sec) of said inner cylinder satisfies any one of the following relations:
(1) When η≦20, d≦5/ω;
(2) When 20<η50, d≦10/ω;
(3) When 50<η≦100, d≦20/ω;
(4) When 100<η.
